(19) United States
(12) Patent Application Publication
(10) Pub. No.: US 2019/0303714 A1
(43) Pub. Date: Oct. 3, 2019

(54) LEARNING APPARATUS AND METHOD THEREFOR

(71) Applicant: CANON KABUSHIKI KAISHA, Tokyo (JP)

(72) Inventor: Yuichiro Iio, Tokyo (JP)

(21) Appl. No.: 16/365,482

(22) Filed: Mar. 26, 2019

(30) Foreign Application Priority Data
Apr. 2, 2018 (JP) 2018-071012

(51) Int. Cl. G06K 9/62

(52) U.S. Cl. CPC G06K 9/6231; G06K 9/628; G06K 9/6256

(57) ABSTRACT

An apparatus includes a learning unit configured to perform learning of a neural network, using a mini batch having a configuration pattern generated based on class information of learning data, and a determination unit configured to determine a configuration pattern to be utilized for next learning, based on a learning result obtained by the learning unit, wherein the learning unit performs next learning, using a mini batch having the determined configuration pattern.

### BACKGROUND OF THE INVENTION

### Field of the Invention

The aspect of the embodiments relates to a learning apparatus and a method for the learning apparatus.

### Description of the Related Art

There has been a technology for learning the content of data such as an image and sound and recognizing the learned content. Here, a target of recognition processing will be referred to as a recognition task. There are various recognition tasks, including a face recognition task for detecting a human face area from an image, an object category recognition task for determining an object (a subject) category (such as a cat, car, or building) in an image, and a scene type recognition task for determining a scene category (such as a city, valley, or shore).

As a technology for learning/executing such a recognition task, a neural network technology is known. A deep multilayer neural network (i.e., having a large number of layers) is called a deep neural network (DNN), and has been attracting attention in recent years because the performance of the DNN is high. Krizhevsky, A., Sutskever, I., & Hinton, G. E., “Imagenet classification with deep convolutional neural networks.”, In Advances in neural information processing systems (pp. 1097-1105), 2012 discusses a deep convolutional neural network. The deep convolutional neural network is called DCNN and has achieved higher performance, in particular, in various recognition tasks for images.

The DNN is configured of an input layer for inputting data, a plurality of intermediate layers, and an output layer for outputting a recognition result. In a learning phase of the DNN, an estimated result output from the output layer and supervisory information are input to a loss function set beforehand, so that a loss (an index that represents the difference between the estimated result and the supervisory information) is calculated. Further, learning is performed to minimize the loss, using back propagation (BP). In the learning of the DNN, in general, a scheme called mini batch learning is used. In the mini batch learning, a certain number of pieces of learning data are extracted from the entire learning data set, and all losses of a group (a mini batch) formed of the extracted certain number of pieces of learning data are determined. Further, the average of the losses is returned to the DNN to update a weight. Repeating the processing until convergence is achieved is the learning processing in the DNN.

However, in the learning of the DNN, it is said that when learning data included in a mini batch is selected from among all the learning data, learning proceeds more efficiently and thus convergence is achieved more quickly in random selection than in fixed-order selection. However, when learning is performed using a mini batch including randomly selected learning data, this learning can result in inefficiency or less accuracy, depending on the type or difficulty of a task addressed by the DNN, or the identity of a learning data set.

### SUMMARY OF THE INVENTION

According to an aspect of the embodiments, an apparatus includes a learning unit configured to perform learning of a neural network, using a mini batch having a configuration pattern generated based on class information of learning data, and a determination unit configured to determine a configuration pattern to be utilized for next learning, based on a learning result obtained by the learning unit, wherein the learning unit performs next learning, using a mini batch having the determined configuration pattern.

Further features of the disclosure will become apparent from the following description of exemplary embodiments with reference to the attached drawings.

### BRIEF DESCRIPTION OF THE DRAWINGS

FIG. 1 is a hardware block diagram illustrating a learning apparatus according to a first exemplary embodiment.

FIG. 2 is a functional block diagram illustrating the learning apparatus according to the first exemplary embodiment.

FIG. 3 is a flowchart illustrating learning processing according to the first exemplary embodiment.

FIG. 4 is a diagram illustrating examples of a configuration pattern.

FIG. 5 is a diagram illustrating an example of a mini batch.

FIG. 6 is a functional block diagram illustrating a learning apparatus according to a third exemplary embodiment.

FIG. 7 is a flowchart illustrating learning processing according to the third exemplary embodiment.

### DESCRIPTION OF THE EMBODIMENTS

Exemplary embodiments of the disclosure will be described below with reference to the drawings.

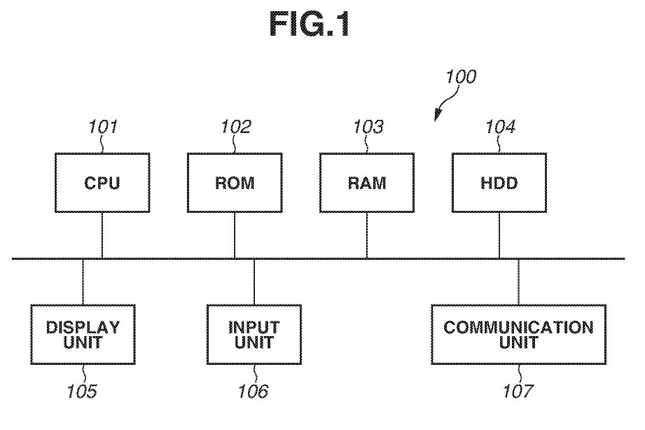

A learning apparatus according to a first exemplary embodiment performs learning efficiently, by appropriately setting a combination of pieces of learning data included in a mini batch, in a multilayer neural network that performs mini batch learning. FIG. 1 is a hardware block diagram illustrating a learning apparatus 100 according to the first exemplary embodiment. The learning apparatus 100 includes a central processing unit (CPU) 101, a read only memory (ROM) 102, a random access memory (RAM) 103, a hard disk drive (HDD) 104, a display unit 105, an input unit 106, and a communication unit 107. The CPU 101 executes various kinds of processing by reading out a control program stored in the ROM 102. The RAM 103 is used as a main memory of the CPU 101, and a temporary storage area such as a work area. The HDD 104 stores various kinds of data and various programs. The display unit 105 displays various kinds of information. The input unit 106 has a keyboard and a mouse, and receives various operations to be performed by a user. The communication unit 107 performs communication processing with an external apparatus via a network.

The CPU 101 reads out a program stored in the ROM 102 or the HDD 104 and executes the read-out program so that the function and the processing of the learning apparatus 100 to be described below are implemented. In another example, the CPU 101 may read out program stored in a storage medium such as a secure digital (SD) card provided in place of the memory such as the ROM 102. In yet another example, at least part of the function and the processing of the learning apparatus 100 may be implemented by, for example, cooperation of a plurality of CPUs, RAMs, ROMs, and storages. In yet another example, at least part of the function and the processing of the learning apparatus 100 may be implemented using a hardware circuit.

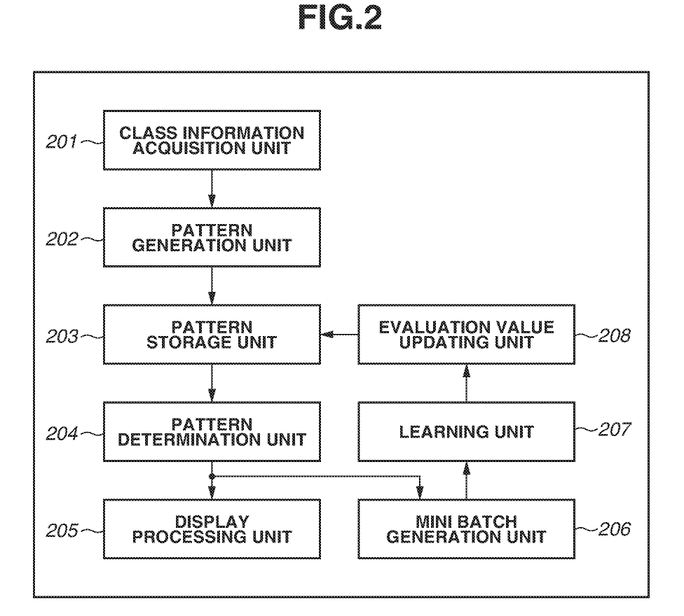

FIG. 2 is a functional block diagram illustrating the learning apparatus 100 according to the first exemplary embodiment. The learning apparatus 100 includes a class information acquisition unit 201, a pattern generation unit 202, a pattern storage unit 203, a pattern determination unit 204, a display processing unit 205, a mini batch generation unit 206, a learning unit 207, and an evaluation value updating unit 208. The class information acquisition unit 201 acquires class information from each piece of learning data. The pattern generation unit 202 generates a plurality of configuration patterns. Here, the configuration pattern represents the pattern of a breakdown of learning data included in a mini batch and in the present exemplary embodiment, the configuration pattern is expressed in class ratio. Further, the configuration pattern includes an evaluation value (an evaluation score) as meta information. The configuration pattern will be described below. The pattern storage unit 203 stores the plurality of configuration patterns generated by the pattern generation unit 202 and the evaluation scores of the respective configuration patterns, in association with each other. The pattern determination unit 204 determines one configuration from among the plurality of configuration patterns, as a configuration pattern to be used for learning. The display processing unit 205 performs control for displaying various kinds of information at the display unit 105.

The mini batch generation unit 206 extracts learning data from a learning data set and generates a mini batch based on the extracted learning data. The mini batch is a learning data group to be used for learning of a deep neural network (DNN). The mini batch generated by the mini batch generation unit 206 of the present exemplary embodiment includes a learning data group for evaluation, in addition to a learning data group for learning. The learning data group for evaluation and the learning data group for learning will be hereinafter referred to as an evaluation set and a learning set, respectively. The learning unit 207 updates a weight of the DNN, using the mini batch as an input. Furthermore, the learning unit 207 evaluates a learning result, using the evaluation set. The evaluation value updating unit 208 updates the evaluation value of the configuration pattern, based on an evaluation result of the evaluation set.

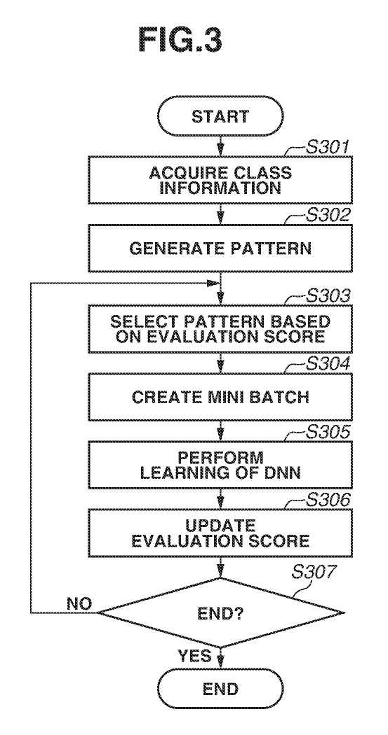

FIG. 3 is a flowchart illustrating learning processing by the learning apparatus 100 according to the first exemplary embodiment. In step S301, the class information acquisition unit 201 acquires class information of each piece of learning data. The class information is a label for classification and expresses the property or category of the learning data. In a case where a task to be addressed by the DNN is a classification task, it may be said that supervisory information of learning data is the class information of the learning data. Further, the user may provide the class information in the learning data beforehand, as meta information (information that accompanies data and serves as additional information about the data itself), other than the supervisory information.

In another example, in a case where learning data does not hold class information, or in a case where learning data holds class information but does not use the class information, the class information acquisition unit 201 may automatically generate class information of learning data in step S301. In this case, the class information acquisition unit 201 classifies the learning data into a plurality of clusters, and generates the classified clusters as class information of each piece of learning data. For example, in a case where a task for detecting a human body area from an image is handled, supervisory information is the human body area in the image, and there is no class information. In this case, the class information acquisition unit 201 may classify learning data beforehand by a supervision-less clustering method based on an extracted arbitrary feature amount, and may label the result of the classification as the class information of each piece of learning data. Furthermore, the class information acquisition unit 201 may classify learning data, using an already learned arbitrary sorter, in place of the supervision-less clustering method.

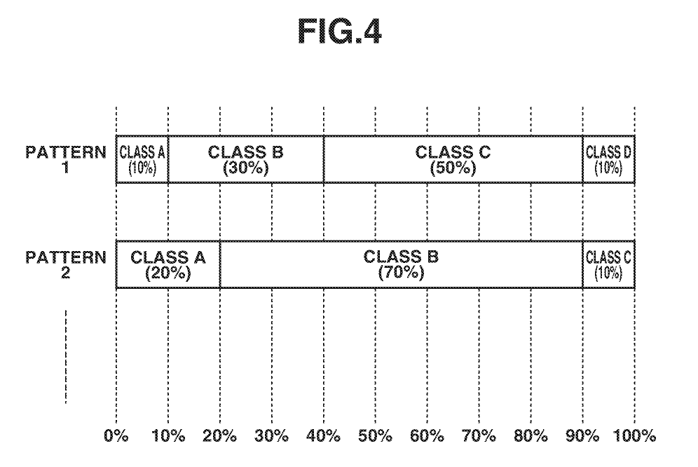

Next, in step S302, the pattern generation unit 202 generates a plurality of configuration patterns. The configuration pattern is information that indicates the proportion of each class of learning data included in a mini batch. FIG. 4 is a diagram illustrating examples of the configuration pattern. A pattern 1 illustrated in FIG. 4 is a configuration pattern of “class A: 10%, class B: 30%, class C: 50%, and class D: 10%”. A pattern 2 is a configuration pattern of “class A: 20%, class B: 70%, class C: 10%, and class D: 0%”. In the process of step S302, only the configuration pattern is generated, and specific learning data included in the mini batch corresponding to the configuration pattern is not determined. In FIG. 4, only two configuration patterns are each illustrated as an example, but the pattern generation unit 202 generates a certain number of configuration patterns at random. The number of configuration patterns to be generated is arbitrary and may be determined beforehand, or may be set by the user. An evaluation score is provided to each configuration pattern as meta information. However, at the time when the configuration patterns are generated in step S302, a uniform value (an initial value) is provided as the evaluation score. The pattern generation unit 202 stores the generated configuration patterns into the pattern storage unit 203.

Next, in step S303, the pattern determination unit 204 selects one configuration pattern as the configuration pattern of a processing target, from the plurality of configuration patterns stored in the pattern storage unit 203. The selection process is an example of processing for determining a configuration pattern. The process is repeated in loop processing of step S303 to step S307, and the pattern determination unit 204 determines the configuration pattern of the processing target at random in the first process of step S303. In and after the second process of step S303, the pattern determination unit 204 selects a configuration pattern of a processing target, based on the evaluation score. The information indicating the configuration pattern selected in step S303 is held during one iteration. The one iteration corresponds to a series of processes performed until the weight of the DNN is updated once in repetition processing (processing of one unit of repetition), and corresponds to the processes of steps S303 to S307.

Here, the second and subsequent processes of step S303 in the repetition processing will be described. The pattern determination unit 204 updates (changes) the probability of selection of each configuration pattern based on the evaluation score, and selects one configuration pattern from among the plurality of configuration patterns, utilizing the updated probability. For example, assume that the evaluation score of a configuration pattern Pi (1<i≤N, where N is the total number of configuration patterns) is Vi. In this case, the pattern determination unit 204 determines a probability Ei of selection of the configuration pattern Pi based on an expression (1). The pattern determination unit 204 then selects a configuration pattern using the probability Ei.

Eᵢ=Vᵢ/Σₖ₌₀^{N}Vₖ (1)

Next, in step S304, the mini batch generation unit 206 creates a mini batch, based on the configuration pattern selected in step S303. The mini batch generation unit 206 generates a mini batch including an evaluation set. The evaluation set is formed of pieces of learning data extracted equally from all the learning data. The proportion of the evaluation set and the number of pieces of learning data of the evaluation set in the mini batch are set beforehand, but are not limited to being set beforehand and may be set by the user. The pieces of learning data included in the evaluation set are randomly selected.

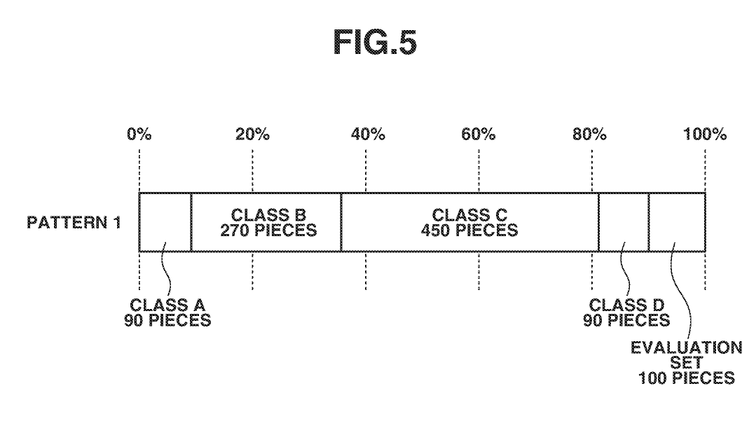

In a case where the mini batch generation unit 206 generates a mini batch having a batch size of 100 and the pattern 1 illustrated in FIG. 4, the mini batch generation unit 206 generates a mini batch illustrated in FIG. 5. In other words, the mini batch includes 900 pieces of learning data as a learning set, and 100 pieces of learning data as an evaluation set. A breakdown of the classes of the learning data is as follows: 90 pieces of learning data of class A, 270 pieces of learning data of class B, 450 pieces of learning data of class C, and 90 pieces of learning data of class D. The mini batch generation unit 206 randomly selects pieces of learning data for each class.

Next, in step S305, the learning unit 207 performs learning of the DNN. In the learning of the DNN, the learning unit 207 receives the learning set of the mini batch as an input, and calculates a loss of each piece of learning data of the learning set by inputting the final output and the supervisory information of the learning set into a loss function. The learning unit 207 then updates the weight of the DNN by performing back propagation for the average of the losses of the respective pieces of learning data of the learning set. In general, a weight of a DNN is updated using an average of all the losses of learning data included in a mini batch. However, in the present exemplary embodiment, a loss of the learning data of the evaluation set is not used to update the weight of the DNN (the loss is not returned to the DNN). In this way, the learning is performed using only the learning set, without using the evaluation set. However, the learning unit 207 calculates the average value of the losses of the learning data of the evaluation set, as the loss of the evaluation set.

Next, in step S306, the evaluation value updating unit 208 updates the evaluation score stored in the pattern storage unit 203, by calculating an evaluation score based on a learning result for the evaluation set. The evaluation score calculated here corresponds to the learning result in step S305 in the immediately preceding loop processing. In the present exemplary embodiment, the evaluation value updating unit 208 calculates the reciprocal number of the loss of the evaluation set calculated in step S305, as the evaluation score. In other words, for the configuration pattern in which the loss of the evaluation set is smaller, the evaluation score is larger. An evaluation score V of a configuration pattern P can be determined by an expression (2), where the loss of the evaluation set of the configuration pattern P is L. Here, a is an arbitrary positive real number. As described above, the selection of the configuration pattern in the present exemplary embodiment is performed based on the evaluation score, and therefore, weighting in the selection can be adjusted by setting of α.

$$V = \frac{α}{L} \qquad ( 2 )$$

However, the evaluation score is not limited to the above-described example, and may be any value, if the value is calculated based on the evaluation set and evaluates the learning result. In another example, accuracy of classifying the evaluation set may be calculated using the class information of the evaluation set as supervisory data, and the calculated accuracy may be used as the evaluation score. In this way, because the mini batch includes the evaluation set, the evaluation score can be automatically calculated each time the learning proceeds by one step. This makes it possible to calculate the evaluation score without reducing the speed of the learning.

Next, in step S307, the learning unit 207 determines whether to end the processing. In a case where a predetermined termination condition is satisfied, the learning unit 207 determines to end the processing. If the learning unit 207 determines to end the processing (YES in step S307), the learning processing ends. If the learning unit 207 determines not to end the processing (NO in step S307), the processing proceeds to step S303. In this case, in step S303, a configuration pattern is selected, and the series of the processes in and after step S304 continues. The termination condition is, for example, a condition such as “accuracy for an evaluation set exceeds a predetermined threshold”, or “learning processing is repeated for a predetermined number of times”. Because the evaluation score is updated to a value other than the initial value in and after the second iteration, the probability corresponding to the evaluation score changes, and a configuration pattern corresponding to a learning result is selected in and after the third iteration.

The display processing unit 205 displays information about a configuration pattern to the user whenever necessary, during and after the learning. The information to be displayed includes a configuration pattern selected during processing, a history of configuration-pattern selection, a list of evaluation scores of configuration patterns, and a history of evaluation score.

As described above, the learning apparatus 100 according to the present exemplary embodiment determines the configuration pattern to be utilized for the next learning, based on the learning result using the mini batch. The learning apparatus 100 can thereby perform the learning in which more appropriate learning data is utilized than in a case where learning data included in a mini batch is selected at random. This accelerates convergence to an optimal solution, and thus convergence to a better local optimal solution easily occurs, so that learning can efficiently proceed.

Next, a learning apparatus 100 according to a second exemplary embodiment will be described focusing on a point different from the learning apparatus 100 according to the first exemplary embodiment. The learning apparatus 100 according to the second exemplary embodiment efficiently performs learning by selecting learning data that produces a high learning effect, when selecting learning data of a learning set. In the second exemplary embodiment, the learning data includes an evaluation score. All the evaluation scores of the learning data have a uniform value (an initial value) in the initial state.

In the second exemplary embodiment, in step S306 (FIG. 3), an evaluation value updating unit 208 updates an evaluation score of learning data, in addition to updating an evaluation score of an evaluation set. The evaluation score of the learning data is determined based on a variation of an evaluation result of an evaluation set included in a mini batch. An evaluation score vp of learning data p can be obtained by an expression (3), where an evaluation result of a mini batch in the kth learning (here, a loss of an evaluation set, as with the first exemplary embodiment) is Lk.

if k=0:vₚ=C

elif Lₖ₋₁<Lₖ:vₚ=vₚ−β

elif Lₖ₋₁=Lₖ:vₚ=vₚ

elif Lₖ₋₁>Lₖ:vₚ=vₚ+β (3)

The evaluation value updating unit 208 holds a value (L_(k−1)) of a loss of an evaluation set in a mini batch in the previous learning. In a case where there is an improvement as a result of comparison between the value (L_(k−1)) and the loss (L_k) of the evaluation set in the mini batch in the current learning (i.e., the loss is reduced), the evaluation value updating unit 208 assumes the learning data included in this mini batch to be effective for learning, and thus increases the evaluation score. On the other hand, in a case where the evaluation result indicates deterioration (i.e., the loss is increased), the evaluation value updating unit 208 assumes the learning data included in this mini batch to be unsuitable for the present learning state, and thus decreases the evaluation score. In the process of step S304 in the second and subsequent rounds in the loop processing, learning data is selected utilizing a probability based on the evaluation score. The process is similar to processing for selecting a configuration pattern. The other configuration and processing of the learning apparatus 100 according to the second exemplary embodiment are similar to those of the learning apparatus 100 according to the first exemplary embodiment.

As described above, the learning apparatus 100 according to the second exemplary embodiment selects not only the configuration pattern but also the learning data, based on the learning result. Therefore, the learning can be performed utilizing more appropriate learning data than in a case where learning data included in a mini batch is selected at random.

Next, a learning apparatus 600 according to a third exemplary embodiment will be described focusing on a point different from the above-described other exemplary embodiments. The learning apparatus 600 according to the third exemplary embodiment separately has an agent for determining a configuration pattern, instead of using a part of a mini batch as an evaluation set and selecting a configuration pattern based on an evaluation score of the evaluation set. Because the configuration pattern is determined based on the agent, it is possible to perform learning efficiently, using a mini batch having an appropriate configuration, while using all the learning data included in the mini batch for the learning.

The agent performs learning, utilizing reinforcement learning that is one type of machine learning. In the reinforcement learning, an agent in a certain environment determines an action to be taken, by observing the current state. The reinforcement learning is a scheme for learning a policy for eventually obtaining a maximum reward through a series of actions. As for reinforcement learning that addresses an issue of the presence of multiple states by combining deep learning and reinforcement learning, see the following document.
V Mnih, et al., “Human-level control through deep reinforcement learning”, Nature 518 (7540), 529-533

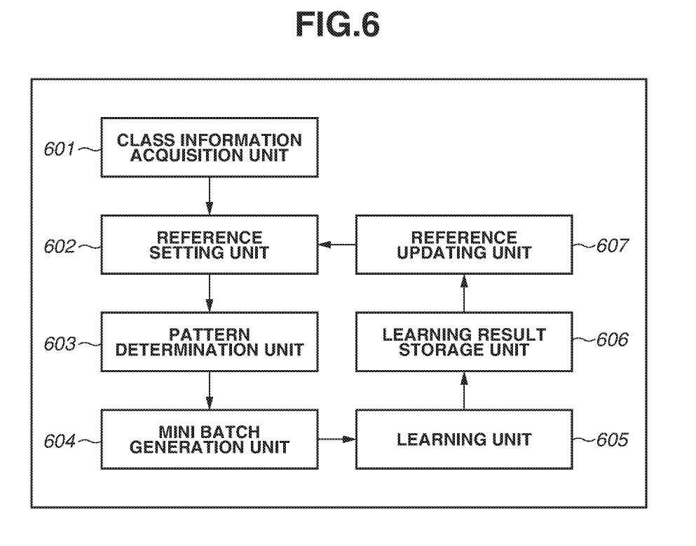

FIG. 6 is a functional block diagram illustrating a learning apparatus 600 according to the third exemplary embodiment. The learning apparatus 600 has a class information acquisition unit 601, a reference setting unit 602, a pattern determination unit 603, a mini batch generation unit 604, a learning unit 605, a learning result storage unit 606, and a reference updating unit 607. The class information acquisition unit 601 acquires class information from each piece of learning data. The reference setting unit 602 sets an agent for determining an appropriate configuration pattern. In the present exemplary embodiment, the appropriate configuration pattern is updated whenever necessary based on the agent. The pattern determination unit 603 determines one appropriate configuration pattern based on the agent. The mini batch generation unit 604 extracts learning data based on the determined configuration pattern and generates a mini batch from the extracted learning data.

The learning unit 605 updates a weight of a DNN by receiving the generated mini batch as an input. The learning result storage unit 606 stores a learning result obtained by the learning unit 605 and the determined configuration pattern in association with each other. The reference updating unit 607 updates the agent by performing learning of the agent for determining an appropriate configuration pattern, using an element stored in the learning result storage unit 606 as learning data.

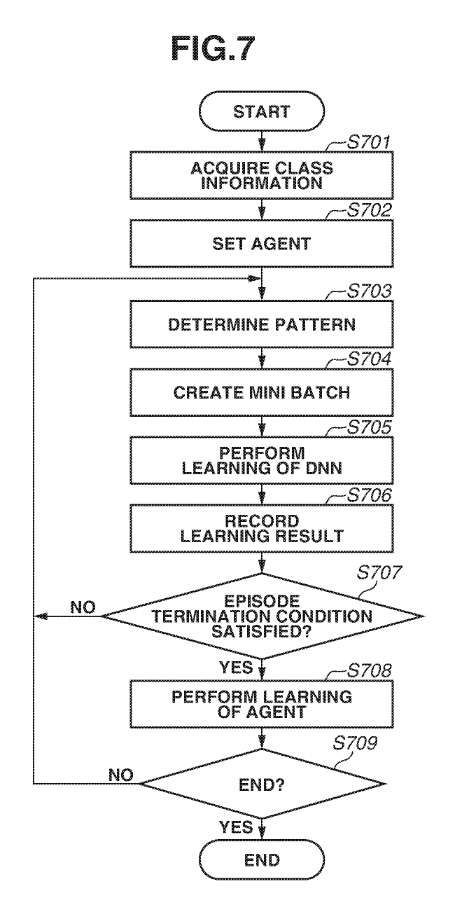

FIG. 7 is a flowchart illustrating learning processing by the learning apparatus 600 according to the third exemplary embodiment. In step S701, the class information acquisition unit 601 acquires class information. The process is similar to step S301 (FIG. 3). Next, in step S702, the reference setting unit 602 sets an agent. The reinforcement learning learns what kind of reward is obtained by performing what “action (a)” in a “certain state (s)” (an action value function Q (s, a)). In the present exemplary embodiment, the current weight parameter of the DNN is set as the state, and a class proportion vector (e.g., a four-dimensional vector in which each element is the proportion of each class, in a case where the number of classes acquired in step S701 is 4) is set as the action. Further, learning is performed so as to minimize a loss of a mini batch after learning is performed for a certain period. A user may freely decide a leaning period. In the present exemplary embodiment, the learning period set by the user will be referred to as an episode.

In the reinforcement learning, learning is performed so that the best reward, not a reward that is temporarily obtained as a result of a certain action, is eventually obtained. In other words, the learning is performed as follows. The action value function does not return a high reward, even if a small loss is temporarily obtained as a result of learning based on a certain configuration pattern. The action value function returns a high reward, in response to selection of a configuration pattern that eventually achieves a small loss based on transition of a configuration pattern within an episode.

Next, in step S703, the pattern determination unit 603 determines an appropriate configuration pattern based on the agent set in step S702 or in immediately preceding step S708 in loop processing. In the first process, the pattern determination unit 603 determines a configuration pattern at random because learning is not yet performed. In this way, an appropriate configuration pattern is automatically determined (generated) based on the learned agent. Next, in step S704, the mini batch generation unit 604 generates a mini batch, based on the configuration pattern determined in step S703. The process is broadly similar to the process of step S304. However, the mini batch generated in step S704 does not include an evaluation set, and includes only a learning set.

Next, in step S705, the learning unit 605 performs learning of the DNN. The process is similar to step S305 (FIG. 3). Next, in step S706, the learning unit 605 records a learning result into the learning result storage unit 606. The information to be recorded includes the determined configuration pattern (an action), a weight coefficient of the DNN before learning (a state), a weight coefficient of the DNN varied by learning (a state after transition by the action), and a loss of the mini batch (a reward obtained by the action). The recorded information (a set of state/action/post-transition state/obtained reward) is added to an accumulation whenever necessary, and is used as learning data in the reinforcement learning.

Next, in step S707, the reference updating unit 607 determines whether an episode termination condition set by the user is satisfied. If the reference updating unit 607 determines that the episode termination condition is satisfied (YES in step S707), the processing proceeds to step S708. If the reference updating unit 607 determines that the episode termination condition is not satisfied (NO in step S707), the processing proceeds to step S703 to repeat the processes. The episode termination condition is a condition freely set by the user. The episode termination condition is, for example, such a condition that “accuracy for evaluation set is improved by a threshold or more” or “learning processing is repeated for a predetermined number of times”.

In step S708, the reference updating unit 607 performs learning of the agent, by randomly acquiring a certain number of pieces from the information recorded in the learning result storage unit 606. The process of the learning is similar to that of an existing reinforcement learning scheme. Next, in step S709, the learning unit 605 determines whether to end the processing. The process is similar to step S307. The other configuration and processing of the learning apparatus 600 according to the third exemplary embodiment are similar to those of the learning apparatus 100 according to each of the above-described other exemplary embodiments.

As described above, the learning apparatus 600 according to the third exemplary embodiment can efficiently perform the learning while using all the learning data included in the mini batch for the learning, by determining the configuration pattern based on the agent.

The exemplary embodiments of the disclosure are described in detail above, but the disclosure is not limited to those specific exemplary embodiments, and various alterations and modifications can be made within the purport of the disclosure described in the scope of claims.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2018-071012, filed Apr. 2, 2018, which is hereby incorporated by reference herein in its entirety.

What is claimed is:

1. An apparatus comprising:
a learning unit configured to perform learning of a neural network, using a mini batch having a configuration pattern generated based on class information of learning data; and
a determination unit configured to determine a configuration pattern to be utilized for next learning, based on a learning result obtained by the learning unit,
wherein the learning unit performs next learning, using a mini batch having the determined configuration pattern.

2. The apparatus according to claim 1, further comprising a configuration pattern generation unit configured to generate a plurality of configuration patterns,
wherein the determination unit determines a configuration pattern among the generated plurality of configuration patterns, as a configuration pattern to be utilized for next learning, based on the obtained learning result.

3. The apparatus according to claim 2, further comprising a change unit configured to change a probability that each of the generated plurality of configuration patterns is determined as a configuration pattern to be utilized for next learning, the probability being changed based on the learning result,
wherein the determination unit determines a configuration pattern to be utilized for next learning, based on a probability changed by the change unit for each of the plurality of configuration patterns.

4. The apparatus according to claim 2, further comprising a storage unit configured to store the generated plurality of configuration patterns and evaluation scores of the respective configuration patterns in association with each other.

5. The apparatus according to claim 1, wherein the configuration pattern represents a pattern of a breakdown of learning data included in a mini batch.

6. The apparatus according to claim 5, wherein the pattern of the breakdown is expressed in class ratio.

7. The apparatus according to claim 6, wherein the configuration pattern includes an evaluation score.

8. The apparatus according to claim 1, further comprising an acquisition unit configured to acquire the class information from the learning data.

9. The apparatus according to claim 8, wherein the acquisition unit classifies the learning data into a plurality of clusters, and generates the clusters as class information of each piece of learning data.

10. The apparatus according to claim 1, further comprising a mini batch generation unit configured to extract learning data from a group of the learning data and to generate a mini batch based on the extracted learning data.

11. The apparatus according to claim 10, wherein the mini batch generation unit generates a learning data group for learning and a learning data group for evaluation, as the mini batch.

12. The apparatus according to claim 1, wherein the learning unit updates a weight of the neural network by calculating losses of respective pieces of the learning data, and performs back propagation for an average of the losses of the learning data.

13. The apparatus according to claim 12, wherein the learning unit receives a learning set of learning data of the mini batch as an input, and calculates the losses of the respective pieces of the learning data by inputting a final output and supervisory information of the learning set into a loss function.

14. The apparatus according to claim 1, further comprising a display control unit configured to display information about the configuration pattern at a display unit, during or after learning by the learning unit.

15. The apparatus according to claim 1, further comprising an evaluation unit configured to evaluate a learning result obtained by the learning unit, using data different from learning data included in the mini batch,
wherein the determination unit determines a configuration pattern to be utilized for next learning, based on an evaluation of the learning result obtained by the evaluation unit.

16. The apparatus according to claim 1, further comprising a selection unit configured to select learning data corresponding to the determined configuration pattern, based on the learning result,
wherein the learning unit performs the learning, using the mini batch including the selected learning data.

17. The apparatus according to claim 16, further comprising a change unit configured to change a probability of selection for each piece of the learning data by the selection unit, based on the learning result,
wherein the selection unit selects learning data corresponding to a configuration pattern, based on the changed probability for each piece of the learning data.

18. The apparatus according to claim 1,
wherein the learning unit performs reinforcement learning of the neural network, and
wherein the determination unit determines a configuration pattern to be utilized for next learning, based on a plurality of learning results obtained by the learning unit.

19. A method comprising:
performing learning of a neural network, using a mini batch having a configuration pattern generated based on class information of learning data; and
determining a configuration pattern to be utilized for next learning, based on a learning result obtained in the learning,
wherein next learning is performed using a mini batch having the determined configuration pattern.

20. A non-transitory computer-readable storage medium storing a program for causing a computer to serve as:
a learning unit configured to perform learning of a neural network, using a mini batch having a configuration pattern generated based on class information of learning data; and
a determination unit configured to determine a configuration pattern to be utilized for next learning, based on a learning result obtained by the learning unit,
wherein the learning unit performs next learning, using a mini batch having the determined configuration pattern.
